(19) United States
(12) Patent Application Publication
(10) Pub. No.: US 2026/0369507 A1
(43) Pub. Date: Nov. 19, 2026

(54) ELECTRICAL CONTACTOR WITH INTEGRATED BREAKING DEVICE

(71) Applicant: SAFRAN ELECTRICAL & POWER, Blagnac (FR)

(72) Inventors: Kévin ENOUF, Blagnac (FR); Guillaume PRIEUR, Blagnac (FR); Jérôme VALIRE, Blagnac (FR)

(73) Assignee: SAFRAN ELECTRICAL & POWER, Blagnac (FR)

(21) Appl. No.: 19/136,700

(22) PCT Filed: Nov. 30, 2023
(86) PCT No.: PCT/FR2023/051875

§ 371 Date: Jun. 6, 2025

(30) Foreign Application Priority Data
Dec. 8, 2022 (FR) FR2212982

(51) Int. Cl. H01H 85/02; H01H 9/10; H01H 9/34; H01H 73/18

(52) U.S. Cl. CPC H01H 85/0241; H01H 9/10; H01H 9/346; H01H 73/18

(57) ABSTRACT

An electrical contactor with a built-in breaking device, including at least one arc breaking device including a first guide, a second guide connected to the contact, and a finned breaking module disposed between the first guide and the second guide. Each arc breaking device includes a fuse disposed between the first arc guide and the second arc guide, and an insulating chamber inside which are disposed the finned breaking module and the fuse, the fuse being separated from at least one of the arc guides by a physical space.

### TECHNICAL FIELD

The invention relates to an item of electrical protection equipment, and more specifically a contactor and electric current circuit breaker intended to be installed in an electrical circuit, for example of an aircraft.

### PRIOR ART

FIGS. 1 to 5 schematically represent different section views of an electrical contactor 1 of the prior art.

The electrical contactor 1 of the prior art comprises two electrically separate fixed electrical contacts 2, a movable bridge 3, and one arc breaking device 4 for each fixed electrical contact 2, or two arc breaking devices 4.

Each arc breaking device 4 includes a first arc guide 5, a second arc guide 6 electrically connected to the fixed electrical contact 2 with which the arc breaking device is associated, and a finned breaking module 7 extending between the first arc guide 5 and the second arc guide 6, at a distance from the movable bridge 3 and from the associated fixed electrical contact 2.

The two first arc guides 5 of the two arc breaking devices 4 are electrically coupled together. And each finned breaking module 7 comprises a series of fins 8 successively disposed on top of one another between the second arc guide 6 and the first arc guide 5, each fin 8 being spaced apart from the other fins by an empty space. The fin 8 at the top of the stack is separated from the first arc guide 5 by an empty space, and the fin at the base of the stack is separated from the second arc guide 6 by an empty space.

The movable bridge 3 is movable between a first position and a second position.

In the first position illustrated on FIG. 1, the movable bridge 3 is mechanically and electrically in contact with the two fixed electrical contacts 2 and at a distance from the two first arc guides 5, and a second position in contact with the first arc guides 5 and at a distance from the fixed electrical contacts 2.

In this first position, the two fixed electrical contacts 2 are electrically connected via the movable bridge 3, thus allowing the electrical current to flow from one fixed electrical contact 2 to the other via the movable bridge 3 as illustrated by the arrows 9 in dash-dotted lines.

In the second position illustrated on FIG. 2, the movable bridge 3 is mechanically separated by two fixed electrical contacts 2 and mechanically and electrically in contact with the two first arc guides 5.

In this second position, the two fixed electrical contacts 3 are electrically decoupled one from the other, and no current can normally flow from one fixed electrical contact 2 to the other.

However, during the separation of the movable bridge 3 with the two fixed electrical contacts 2, an electric arc 10 can form by ionization of the air at each of the two places of separation as illustrated on FIG. 3. An electrical current then always flows from one fixed electrical contact 2 to the other via the movable bridge 3 as illustrated by the arrows 9 in dash-dotted lines.

As illustrated on FIGS. 4 and 5, the electrical arcs 10 will then move outward via the first arc guides 5 and the second arc guides 6 owing to the Laplace force which is created between the electric current 9 and the magnetic field 11. The electric arcs 10, under the effect of the magnetic field 11 created by permanent magnets, bend and then lick the first and second arc guides 5 and 6.

As illustrated on FIG. 6, the electric arcs 10 thus move all the way into the finned breaking modules 7. Once the electric arcs 10 have entered the fins 8 of the finned breaking module 7, the arc will split into multiple arcs which will make the current drop to zero and cause the breaking of the network.

However, when the current is too high, it is possible that the fins 8 of the finned breaking module 7 will no longer be enough and that the electric arc will cross them and come out on the other side. The arc then completely reforms and will not be extinguished as illustrated on FIG. 7.

Since an electric arc 10 is a plasma which can reach several thousands of degrees Celsius, if it is sustained for too long, it can damage the rest of the electrical contactor and potentially propagate.

There is therefore a need for an additional protection system making it possible to contain and/or limit the propagation of electric arcs.

Solutions exist on high-voltage DC networks (HVDC), particularly in the automotive sector. These solutions consist in the insertion of a fuse or pyrotechnic fuse devices (pyrofuses) capable of interrupting very high currents in series with the contactors. But these solutions but are not contactors. The drawback of its solutions is that they are cumbersome, heavy and not very easy to incorporate at the input of an electrical contactor.

These solutions are particularly described in the documents CN 210837635, FR 3098005, U.S. Pat. No. 11,052,784, DE 102020006947, and EP 3698419.

### SUMMARY OF THE INVENTION

The invention aims to supply a technical solution offering an electrical contactor capable of containing electric arcs to avoid their external propagation and thus to suppress them.

In a first subject of the invention, provision is made for an electrical contactor with a built-in electrical breaking device, said electrical contactor comprising at least one arc breaking device including a first arc guide, a second arc guide, and a finned breaking module extending between the first arc guide and the second arc guide.

According to a general feature of the invention, the arc breaking device further includes a fuse and an electrically insulating chamber, the fuse being disposed between the first arc guide and the second arc guide and separated from at least one of the arc guides from among the first arc guide and the second arc guide by a physical space, and the finned breaking module and the fuse being disposed inside the electrically insulating chamber.

The addition of a fuse in the electrical contactor, this fuse being physically separated, in other words distant, from at least one of the two arc guides, makes it possible to have an arc breaking device equipped with a fuse which only allows the current to pass when the electric arc exits the fins of the finned breaking module, for example following a short-circuit, such that the rating of the fuse and therefore its size are not necessarily large.

The finned breaking module therefore makes it possible to break the electric arcs generated with a nominal current, and the fuse makes it possible to break the electric arcs generated with a current greater than the nominal current, the arc then exiting the fins of the finned breaking module and forming between the arc guides and the fuse.

The insulating chamber meanwhile makes it possible to insulate the cartridge of the fuse and to block the arc so that it catches on the end of the fuse.

Preferably, the electrical contactor with built-in electrical breaking device comprises at least two electrically separate fixed electrical contacts, a movable bridge, and an arc breaking device for each fixed contact, each arc breaking device including a first arc guide, a second arc guide electrically connected to the associated fixed contact, and a finned breaking module extending between the first arc guide and the second arc guide, distant from the movable bridge and from the associated fixed contact, the first arc guides of the different arc breaking devices being electrically coupled together, and the movable bridge being movable between a first position in contact with said fixed contacts and at a distance from the first arc guides, and a second position in contact with the first arc guides and at a distance from said fixed contacts.

In a first embodiment of the electrical contactor, each arc breaking device may further comprise an electrically insulating inner wall disposed between the fuse and the finned breaking module.

The insulating inner wall thus makes it possible to protect the fuse and avoid an arc forming between a fin of the finned breaking module and the fuse.

In another embodiment of the electrical contactor, each arc breaking device may comprise a first electrical branch including a first end electrically connected to a first of the two terminals of the fuse and a second end electrically connected to the second arc guide, and a second electrical branch including a first end connected to a second of the two terminals of the fuse and a second end disposed facing the first arc guide while remaining at a distance from said finned module and from the first arc guide, the second end of the second electrical branch being separated from the first arc guide by said physical space.

In a practical implementation of the electrical contactor, for each arc breaking device, the finned breaking module may comprise first fins located near the second arc guide which are larger than second fins located near the first arc guide.

The ends extended at the bottom part of the finned breaking module make it possible to have an obtained resistance of the electrical arc that is greater than that of the fuse branch, thus promoting the passage of the current through the fuse.

Advantageously, for each arc breaking device, at least a part of the first arc guide and at least a part of the second arc guide can be disposed inside the insulating chamber.

### BRIEF DESCRIPTION OF THE DRAWINGS

The invention will be better understood on reading the text below, given for information purposes but non-limiting, with reference to the appended drawings on which:

FIG. 1, already described, schematically represents a section view of an electrical contactor 1 of the prior art in a first position.

FIG. 2, already described, schematically represents a section view of the electrical contactor 1 of the prior art in a second position.

FIG. 3, already described, schematically represents a section view of the electrical contactor 1 of the prior art of FIG. 2 with the appearance of electric arcs.

FIG. 4, already described, schematically represents a section view of the electrical contactor 1 of the prior art of FIG. 2 with the electric arcs moving outward.

FIG. 5, already described, schematically represents a section view of the electrical contactor 1 of the prior art of FIG. 2 with the electric arcs further outward.

FIG. 6, already described, schematically represents a section view of the electrical contactor 1 of the prior art of FIG. 2 with the electric arcs moved into the finned breaking module.

FIG. 7, already described, schematically represents a section view of the electrical contactor 1 of the prior art of FIG. 2 with the electric arcs outside the finned breaking module.

FIG. 8 schematically represents a section view of an electrical contactor 10 according to a first embodiment of the invention in a first position.

FIG. 9 schematically represents a section view of the electrical contactor 10 of FIG. 8 in a second position.

FIG. 10 schematically represents the direction of the current in the contactor of FIG. 9 when an electric arc forms outside the finned breaking module 23.

FIG. 11 schematically represents a section view of an electrical contactor 10′ according to a second embodiment of the invention.

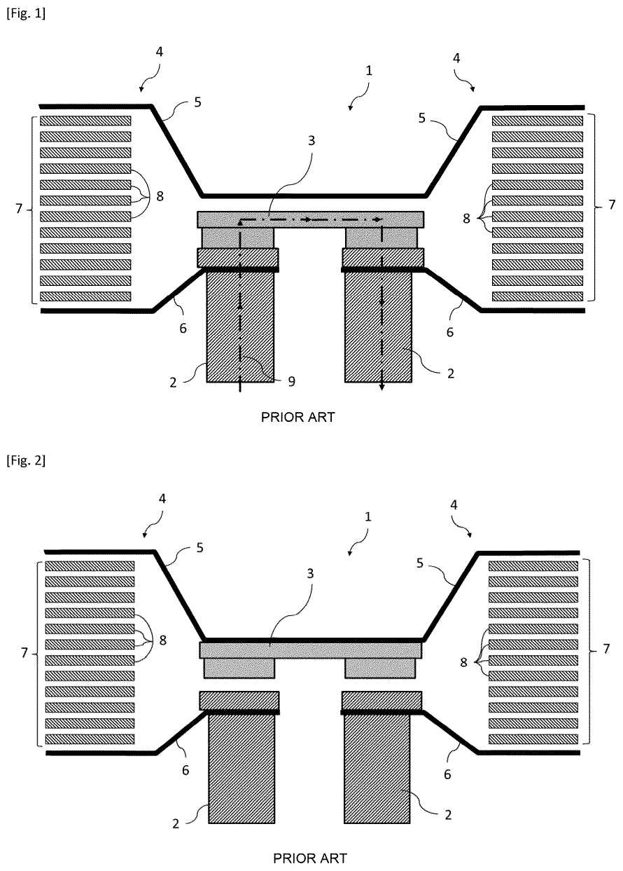

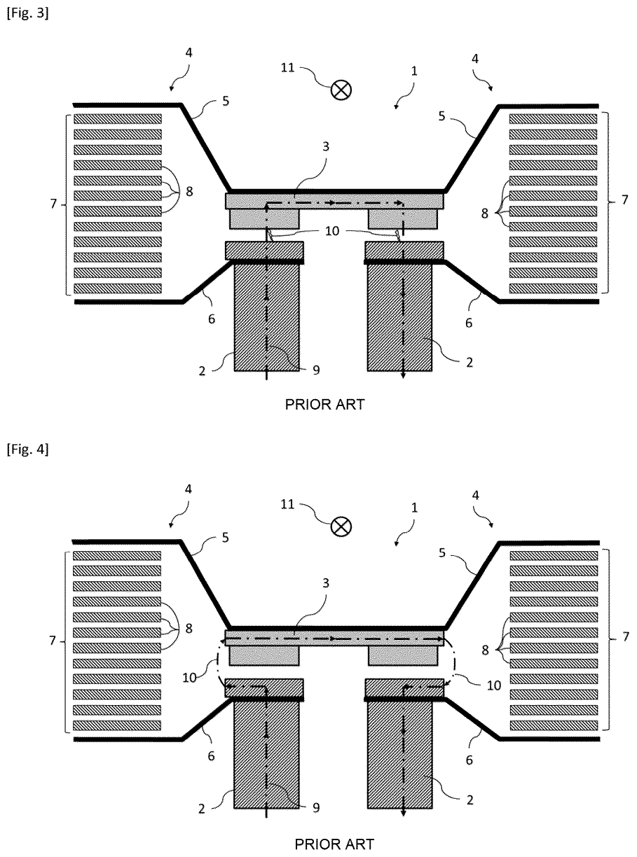

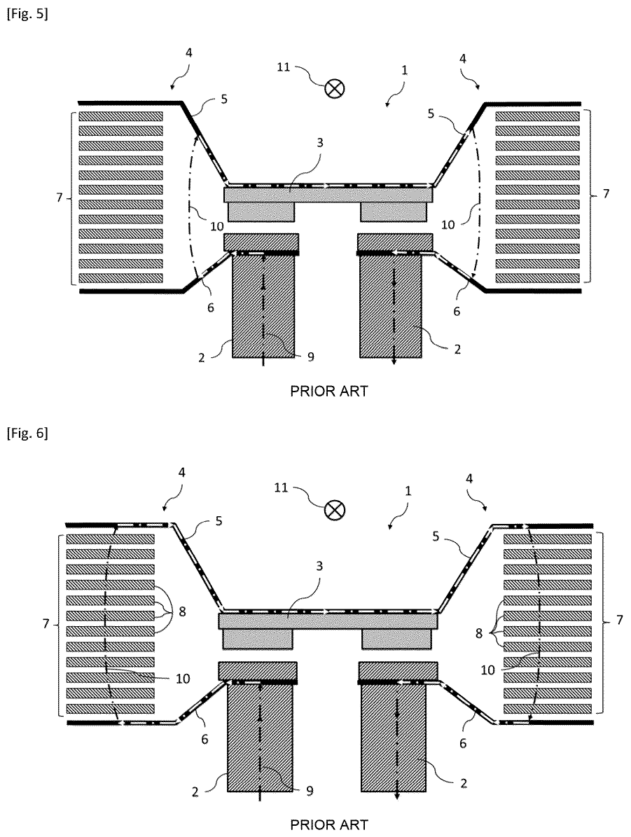

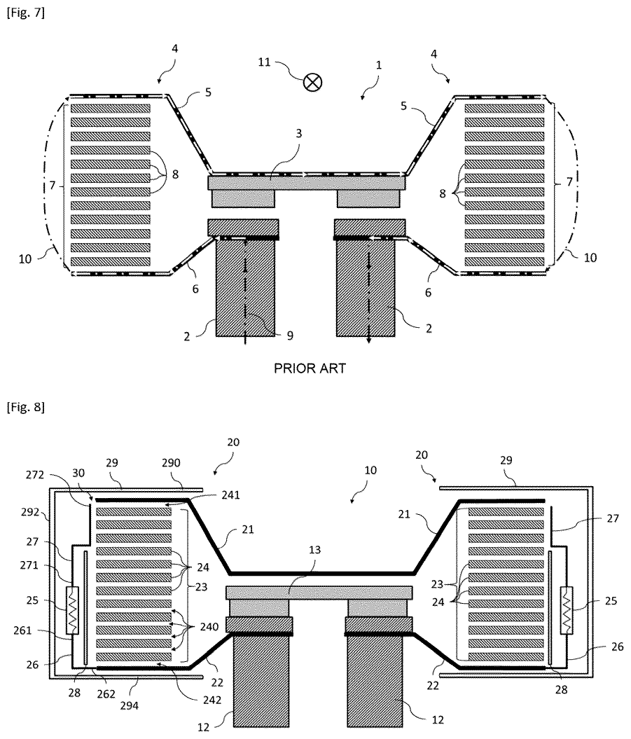

### DESCRIPTION OF THE EMBODIMENTS

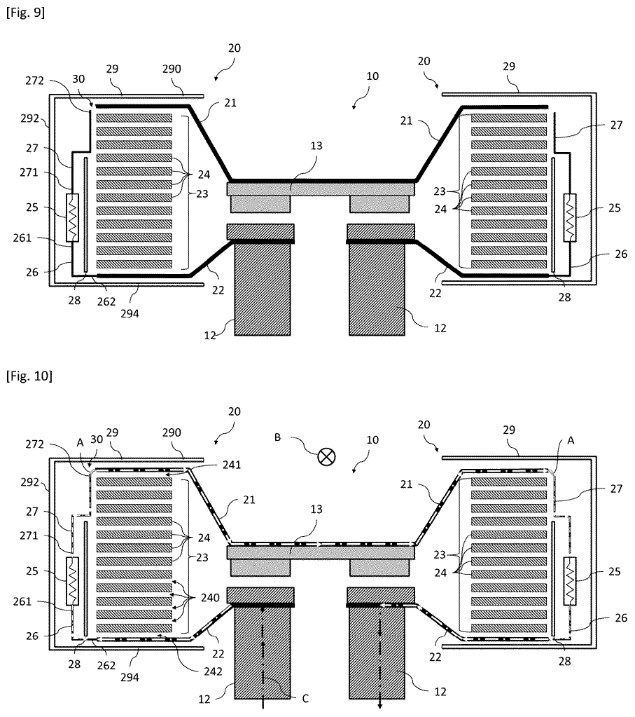

FIG. 8 schematically represents a section view of an electrical contactor 10 with a built-in electrical breaking device according to a first embodiment of the invention.

In the embodiment illustrated on FIG. 8, the electrical contactor 1 comprises two fixed electrical contacts 12 which are electrically separate, a movable bridge 13, and, for each fixed contact 12, an arc breaking device 20, in other words two arc breaking devices 20.

Each arc breaking device 20 includes a first arc guide 21, a second arc guide 22 electrically connected to the associated fixed contact 12, and a finned breaking module 23 including a plurality of fins 24 and extending between the first arc guide 21 and the second arc guide 22. The finned breaking module 23 is disposed at a distance from the movable bridge 13 and from the adjacent fixed contact 12.

The first arc guides 21 of the two arc breaking devices 20 are electrically coupled together.

The fins 8 of a finned breaking module 23 are successively superimposed on top of one another between the second arc guide 22 and the first arc guide 21. Each fin 24 is separated from another fin 24 by an empty gap 240, and is therefore not in electrical contact with another fin 24. The fin 24 at the top of the superposition is separated from the first arc guide 21 by a top empty gap 241, and the fin at the base of the superimposition is separated from the second arc guide 21 by another base empty gap 242.

As illustrated on FIGS. 8 and 9, the movable bridge 13 is movable between a first position illustrated on FIG. 8, in which the movable bridge 13 is in contact with the fixed contacts 12 and at a distance from the first arc guides 21, and a second position, illustrated on FIG. 9, in which the movable bridge 13 is in contact with the first arc guides 13 and at a distance from the fixed contacts 12. In the first position, the current flows from a fixed contact 12 to the other fixed contact 12 via the movable bridge 13. In the second position, no current is intended to flow from one fixed contact to the other, unless an electric arc forms between the movable bridge and a fixed contact 12.

Each arc breaking device 20 further comprises a fuse 25 disposed between the first arc guide 21 and the second arc guide 22, a first electrical branch 26 coupled with a first terminal of the fuse 25 and a second electrical branch 27 coupled with a second terminal of the fuse 25.

The first electrical branch 26 includes a first end 261 electrically connected to the first terminal of the fuse 25 and a second end 262 electrically connected to the second arc guide 22. The second electrical branch 27 includes a first end 271 electrically connected to the second terminal of the fuse 25 and a second end 272 disposed facing the first arc guide 21 but at a distance from the first arc guide 21. The second end 272 of the second electrical branch 27 is thus physically separated from the first arc guide 21 by a physical space 30, and is only in direct electrical contact with no other electrical element.

Each arc breaking device 20 also comprises an inner wall 28 which is electrically insulating and disposed between the fuse 25 and at least a part of the finned breaking module 23. The inner wall 28 thus extends over a length greater than that of the fuse 25 but less than that of the finned breaking module 23.

Each arc breaking device 20 also comprises an electrically insulating chamber 29 inside which are disposed the finned breaking module 23, the fuse 25, the first electrical branch 26, the second electrical branch 27, and the inner wall 28. The chamber 29 in this example comprises three outer walls 290, 292 and 294. A first wall 290 is disposed facing a portion of the first arc guide 21, a second wall 292 is disposed facing the fuse 25, and a third wall 294 is disposed facing the second arc guide 22. The second wall 292 is secured to the first wall 290 and to the third wall 294.

The physical space 30 for which provision is made between the first end 272 of the second electrical branch 27 and the first arc guide 21 thus offers a priority electric arc generation path, when the electric arc exits the finned breaking module 23, for example during a short-circuit with a non-nominal current. The electric arc is confined inside the electrically insulating chamber 29 and the shortest and most favorable path to form by ionization in the air is the path through the physical space 30 separating the second end 272 of the second electrical branch 27 from the first arc guide 21.

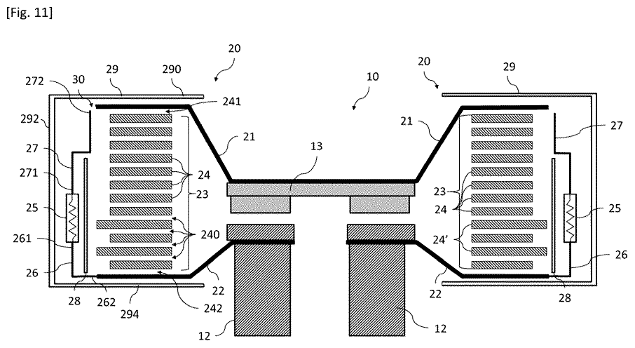

As illustrated on FIG. 10, once an electric arc A is formed between the second end 272 of the second electrical branch 27 and the first arc guide 21 of each of the arc breaking devices 20, a current C flows from one of the contacts 12 to the other contact 12 by passing, in a first arc breaking device 20 via the second arc guide 22, the first electrical branch 26, the fuse 25, the second electrical branch 27, the physical space 30, the first arc guide 21, then in the second arc breaking device 20 via the first arc guide 21, the physical space 30, the second electrical branch 27, the fuse 25, the first electrical branch 26, and the second arc guide 22. This is done until one of the fuses 25 melts and thus breaks the electrical circuit.

FIG. 11 schematically illustrates a section view of an electrical contactor 10′ according to a second embodiment of the invention.

The second embodiment illustrated on FIG. 11 differs from the first embodiment illustrated on FIGS. 8 and 9 in that the finned breaking module 23 of the arc breaking devices 20 comprise base fins 24′ located in the bottom position, i.e. closer to the second arc guide 22 than to the first arc guide 21, which are longer than the other fins 24.

The base fins 24′ which are thus extended in the bottom part of the finned breaking module 23 make it possible to have an obtained resistance of the electric arc that is greater than that of the circuit formed by the fuse 25 and the first and second electrical branches 26 and 27, thus promoting the passage of the current through the fuse 25 rather than between the fins 24 or 24′.

1. An electrical contactor with a built-in electrical breaking device, said electrical contactor comprising at least two fixed electrical contacts that are electrically separate and each connected to a separate second arc guide, a movable bridge, and, for each fixed electrical contacts, one arc breaking device including a first arc guide, a second arc guide, and a finned breaking module extending between the first arc guide and the second arc guide,
wherein the arc breaking device further includes a fuse and an electrically insulating chamber, the fuse being disposed between the first arc guide and the second arc guide and separated from at least one of the arc guides from among the first arc guide and the second arc guide by a physical space, and the finned breaking module and the fuse being disposed inside the electrically insulating chamber.

2. The electrical contactor as claimed in claim 1, wherein the finned breaking module of each arc breaking device being disposed at a distance from the movable bridge and from the associated fixed contact, the first arc guides of the different arc breaking devices being electrically coupled together, and the movable bridge being movable between a first position in contact with said fixed contacts and at a distance from the first arc guides, and a second position in contact with the first arc guides and at a distance from said fixed contacts.

3. The electrical contactor as claimed in claim 2, wherein each arc breaking device further comprises an electrically insulating inner wall disposed between the fuse and the finned breaking module.

4. The electrical contactor as claimed in claim 2, wherein each arc breaking device comprises a first electrical branch including a first end electrically connected to a first of the two terminals of the fuse and a second end electrically connected to the second arc guide, and a second electrical branch including a first end connected to a second of the two terminals of the fuse and a second end disposed facing the first arc guide while remaining at a distance from said finned module and from the first arc guide, the second end of the second electrical branch being separated from the first arc guide by said physical space.

5. The electrical contactor as claimed in claim 1, wherein, for each arc breaking device, the finned breaking module comprises first fins located near the second arc guide which are larger than second fins located near the first arc guide.

6. The electrical contactor as claimed in claim 2, wherein, for each arc breaking device, at least a part of the first arc guide and at least a part of the second arc guide are disposed inside the insulating chamber.
